(19) United States
(12) Patent Application Publication
(10) Pub. No.: US 2018/0319986 A1
(43) Pub. Date: Nov. 8, 2018

(54) PROCESSING AID COMPOSITION COMPRISING A SULFONATE-CONTAINING FLUORINATED POLYMER

(71) Applicant: 3M INNOVATIVE PROPERTIES COMPANY, St. Paul, MN (US)

(72) Inventors: Claude Lavallée, Maplewood, MN (US); Denis Duchesne, Woodbury, MN (US); Werner M.A. Grootaert, Oakdale, MN (US); Miguel A. Guerra, Woodbury, MN (US)

(21) Appl. No.: 15/774,823

(22) PCT Filed: Nov. 8, 2016
(86) PCT No.: PCT/US2016/060888

§ 371 Date: May 9, 2018

Related U.S. Application Data
(60) Provisional application No. 62/253,293, filed on Nov. 10, 2015.

(51) Int. Cl. C08L 101/04; C08L 101/12; C08L 81/08; C08L 67/04; C08L 23/08

(52) U.S. Cl. CPC C08L 101/04; C08L 101/12; C08L 2203/30; C08L 67/04; C08L 23/08; C08L 81/08

(57) ABSTRACT

Described herein is a melt-processible polymer composition comprising: a non-fluorinated melt-processible polymer; and a fluorine-containing polymer comprising at least three —(SO₃⁻)iM⁺ⁱ groups per polymer chain wherein M is a cation; and i is an integer.

### TECHNICAL FIELD

The present disclosure relates to polymer compositions that comprise a mixture of a non-fluorinated melt-processible polymer and a fluorine-containing polymer, wherein the fluorine-containing polymer comprises at least three sulfonate groups per polymer chain. The fluorine-containing polymer may be used as a polymer processing aid.

### BACKGROUND

For any melt processible thermoplastic polymer composition, there exists a critical shear rate above which the surface of the extrudate becomes rough and below which the extrudate will be smooth. See, for example, R. F. Westover, Melt Extrusion, Encyclopedia of Polymer Science and Technology, Vol. 8, pp 573-81 (John Wiley & Sons 1968). The desire for a smooth extrudate surface competes, and must be optimized with respect to, the economic advantages of extruding a polymer composition at the fastest possible speed (i.e. at high shear rates).

Some of the various types of extrudate roughness and distortion observed in high and low density polyethylenes are described by A. Rudin, et al., in Fluorocarbon Elastomer Aids Polyolefin Extrusion, Plastics Engineering, March 1986, on 63-66. The authors state that for a given set of processing conditions and die geometry, a critical shear stress exists above which polyolefins such as linear low-density polyethylene (LLDPE), high-density polyethylene (HDPE), and polypropylene suffer melt defects. At low shear rates, defects may take the form of “sharkskin”, a loss of surface gloss that in more serious manifestations appears as ridges running more or less transverse to the extrusion direction.

At higher rates, the extrudate can undergo “continuous melt fracture” becoming grossly distorted. At rates lower than those at which continuous melt fracture is first observed, LLDPE and HDPE can also suffer from “cyclic melt fracture”, in which the extrudate surface varies from smooth to rough. The authors state further that lowering the shear stress by adjusting the processing conditions or changing the die configuration can avoid these defects to a limited extent, but not without creating an entirely new set of problems.

For example, extrusion at a higher temperature can result in weaker bubble walls in tubular film extrusion, and a wider die gap can affect film orientation.

There are other problems often encountered during the extrusion of thermoplastic polymers. They include a build-up of the polymer at the orifice of the die (known as die build up or die drool), increase in back pressure during extrusion runs, and excessive degradation or low melt strength of the polymer due to high extrusion temperatures. These problems slow the extrusion process either because the process must be stopped to clean the equipment or because the process must be run at a lower speed.

### SUMMARY

Despite the many existing processing aids based on fluoropolymers as known in the art, there continues to be a need to find further processing aids. The present disclosure is related to a fluorinated polymer that may be used as a processing aid in melt-processible polymers. Desirably, such processing aids are highly effective in reducing melt defects in the processing, in particular extrusion, of non-fluorinated melt-processible polymers. Preferably, the processing aid is capable of alleviating melt defects and/or reducing die drool and/or reducing the back pressure during extrusion of the non-fluorinated polymer.

In one embodiment, a melt-processible polymer composition is provided comprising:

a non-fluorinated melt-processible polymer; and

a fluorine-containing polymer comprising at least three —(SO₃⁻)ᵢM⁺ⁱ groups per polymer

chain wherein M is a cation; and i is an integer.

In another embodiment, a polymer melt additive composition for use as a processing aid in the extrusion of a non-fluorinated polymer is provided, the polymer melt additive composition comprising a non-fluorinated melt-processible polymer and a fluorine-containing polymer comprising at least three —(SO₃⁻)ᵢM⁺ⁱ groups per polymer chain wherein M is a cation; and i is an integer.

In another embodiment, a polymer melt additive composition for use as a processing aid in the extrusion of a non-fluorinated polymer is described, the polymer melt additive composition comprising (a) a fluorine-containing polymer comprising an acidic end-group concentration of greater than 10 meq/kg and (b) a plurality of trivalent or tetravalent cations.

In yet another embodiment, a method for making a polymer melt additive composition is described comprising:

polymerizing a fluorine-containing polymer; and

coagulating the fluorine-containing polymer with (a) acid coagulation or (b) use of a trivalent or tetravalent salt.

wherein the fluorine-containing polymer comprises (i) a —(SO₃⁻)ᵢM⁺ⁱ group wherein M is a cation; and i is an integer and (ii) an acidic end-group concentration of greater than 10 meq/kg of fluorine-containing polymer.

The above summary is not intended to describe each embodiment. The details of one or more embodiments of the invention are also set forth in the description below. Other features, objects, and advantages will be apparent from the description and from the claims.

### DETAILED DESCRIPTION

As used herein, the term

“a”, “an”, and “the” are used interchangeably and mean one or more.

“and/or” is used to indicate one or both stated cases may occur, for example A and/or B includes, (A and B) and (A or B);

“alkyl” means a linear or branched, cyclic or acyclic, saturated monovalent hydrocarbon having from one to about twelve carbon atoms, e.g., methyl, ethyl, 1-propyl, 2-propyl, pentyl, and the like;

“aryl” means a monovalent aromatic, such as benzyl, phenyl, and the like;

“backbone” refers to the main continuous chain of the polymer;

“end-group” refers to side chains off the polymer backbone or terminal groups, wherein a terminal group is formed by the initiation or termination of the polymerization;

“linking group” means a divalent linking group. In one embodiment, the linking group includes at least 1 carbon atom (in some embodiments, at least 2, 4, 8, 10, or even 20 carbon atoms). The linking group can be a linear or branched, cyclic or acyclic structure, that may be saturated or unsaturated, substituted or unsubstituted, and optionally contains one or more hetero-atoms selected from the group consisting of sulfur, oxygen, and nitrogen, and/or optionally contains one or more functional groups selected from the group consisting of ester, amide, sulfonamide, carbonyl, carbonate, urethane, urea, and carbamate. In another embodiment, the linking group does not comprise a carbon atom and is a catenary heteroatom such as oxygen, sulfur, or nitrogen;

“monomer” is a molecule which can undergo polymerization which then form part of the essential structure of a polymer;

“melt-processible” or “suitable for melt-processing” is meant that the respective polymer or composition can be processed in commonly used melt-processing equipment such as, for example, an extruder. For example, a melt processible polymer may typically have a melt flow index of 5 g/10 minutes or less, preferably 2 g/10 minutes or less (measured according to ASTM D1238 at 190 C, using a 2160 g weight) but still more than 0.2 g/10 minutes. A melt-processible polymer may also have a melt flow index (MFI 265/5) of 20 g/10 minutes or less or 12 g/min or less but greater than 0.1 g/10 min.

“sulfonate” is used to indicate both sulfonic acids (e.g., —SO₃H) and salts thereof (e.g., —SO₃Na, —SO₃NH₄);

“perfluorinated” means a group or a compound wherein all hydrogen atoms in the C—H bonds have been replaced by C—F bonds; and

“polymer” refers to a macrostructure comprising interpolymerized units of monomers.

Also herein, recitation of ranges by endpoints includes all numbers subsumed within that range (e.g., 1 to 10 includes 1.4, 1.9, 2.33, 5.75, 9.98, etc.).

Also herein, recitation of “at least one” includes all numbers of one and greater (e.g., at least 2, at least 4, at least 6, at least 8, at least 10, at least 25, at least 50, at least 100, etc.).

Fluorine-Containing Polymers

The fluorine-containing polymer of the present disclosure comprises a plurality of sulfonate groups (i.e., (SO₃⁻)ᵢM⁺¹ groups, wherein M is a cation; and i is an integer).

The fluorine-containing polymer of the present disclosure comprises at least 3, 5, or even 10 sulfonate groups per polymer chain. The amount of sulfonate groups can be determined by chemical analysis (such as NMR) or titrometry.

In one embodiment, the fluorine-containing polymer has an acidic end-group concentration of greater than 10, 20, 30, 40, or even 50 meq/kg (milliequivalents per kg of polymer). This acidic groups can be a result of not only the sulfonate groups, but other groups such as carboxyl group, hydroxyl group, sulfate group, sulfonic group, acid fluoride group, and amide groups, which are present based on the reaction materials (e.g., initiator, chain transfer agent, cure site monomer, solvent, contaminants, etc.) used during the polymerization and processing conditions the polymer experiences, which result in the polymer have acidic side chains or acidic terminal groups.

Fluorine-containing polymers having sulfonate groups are known, for example, in the fuel cell and ion exchange art. See for example U.S. Pat. Nos. 8,927,612 (Zhang et al.) and 7,517,604 (Hamrock et al.); and C.N. Pat. Publ. No. 101775095 (Goa, et al.).

In one embodiment, the fluorine-containing polymer may be derived from the polymerization of sulfinate group-containing monomers, forming a polymer with pendent sulfinate groups, which is then subsequently oxidized to convert the sulfinate groups to sulfonate groups.

In one embodiment, the fluorine-containing polymer may be derived from the polymerization of sulfonyl fluoride group-containing monomers, forming a polymer with pendent sulfonyl fluoride groups, which is then subsequently hydrolyzed to convert the sulfonyl fluoride groups to sulfonate groups.

In another embodiment, the fluorine-containing polymer may be derived from the polymerization of sulfonate-containing monomers. Such sulfonate-containing monomers include:

(CX₁X₃═CX₂—(R)ₚ—CZ₁Z₂—SO₃⁻)ᵢM⁻ⁱ Formula (I)

wherein X₁, X₂, and X₃ are each independently selected from H, F, Cl, a C₁ to C₄ alkyl group, and a C₁ to C₄ fluorinated alkyl group; R is a linking group; Z₁ and Z₂ are independently selected from H, CH₃, F, CF₃, an alkyl group, and a perfluorinated alkyl group; p is 0 or 1; and M is a cation.

In one embodiment R may be non-fluorinated, partially fluorinated, or perfluorinated. In some embodiments, a hydrogen atom in R may be replaced with a halogen other than fluorine, such as a chlorine. R may or may not comprise double bonds. R may be substituted or unsubstituted, linear or branched, cyclic or acyclic, and may optionally comprise a functional group (e.g., esters, ethers, ketones, amines, halides, etc.). In one embodiment, R is a catenary heteroatom such as oxygen, sulfur, or nitrogen.

In one embodiment, R is selected from: —(CH₂)ₐ—, —(CF₂)ₐ—, —O—(CF₂)ₐ—, —(CF₂)ₐ—O—(CF₂)_{b}—, —O(CF₂)ₐ—O—(CF₂)_{b}—, —(CF₂)ₐ—[O—(CF₂)_{b}]_{c}—, —O—(CF₂)ₐ[O—(CF₂)_{b}]_{c}—, —[(CF₂)ₐ—O]_{b}—[CF₂)_{c}—O]_{d}—, —O[(CF₂)ₐ—O]_{b}—[(CF₂)_{c}—O]_{d}—, —O—[CF₂CF(CF₃)O]ₐ—(CF₂)_{b}—, and combinations thereof, wherein a, b, c, and d are independently at least 1, 2, 3, 4, 10, 20, etc.

As used herein M represents a cation. M can comprise at least one of a hydrogen, an alkali metal, alkaline earth metal, an organic quaternary onium group (such as a quaternary organo ammonium, and a quaternary organo phosphonium), an inorganic quaternary onium group (such as a quaternary ammonium, NH₄⁺), an organic ternary onium group (such as an organosulfonium), an inorganic ternary onium group, and combinations thereof. Exemplary cations include H⁺, NH₄⁺, Na⁺, Cs⁺, Ca⁺², K⁺, Mg⁺², Zn⁺², and, Al⁺³, Fe⁺³, Ce⁺⁴ and/or an organic cation including, but not limited to N(CH₃)₄⁺, NH₂(CH₃)₂⁺, N(CH₂CH₃)₄⁺, NH(CH₂CH₃)₃⁺, NH(CH₃)₃⁺, ((CH₃CH₂CH₂CH₂)₄)P⁺, and combinations thereof. Specific examples of organooniums include triphenylbenzyl phosphonium, tributyl alkyl phosphonium, tributyl benzyl ammonium, tetrabutyl ammonium, tetrahexyl ammonium, tributyl(2-methoxy)propyiphosphonium, amino-phosphonium, and triarylsulfonium. In one embodiment, M comprises Al⁺³, Fe⁺³, Ce⁺⁴, and combinations thereof.

Such sulfonate-containing monomers may be made by hydrolyzing a sulfonyl fluoride containing monomer such as those described in U.S. Pat. No. 6,624,328 (Guerra).

In one embodiment, the sulfonate-containing monomer is selected from the group consisting of: (CF₂═CF—O(CF₂)ₙ—SO₃⁻)ᵢM⁺¹, (CF₂═CF—O[CF₂CF(CF₃)O]ₙ(CF₂)ₒ—SO₃⁻)ᵢM⁺ⁱ; (CH₂═CH—(CF₂)ₙ—SO₃⁻)ᵢM⁺ⁱ; and combinations thereof, where n is at least 1; o is at least 1; and M is a cation as defined above and i is an integer.

In the polymerization, the optimal amount of sulfonate-containing monomer used can be readily determined by one skilled in the art, but is generally not more than 5% by weight. In one embodiment, at least 0.05, 0.1, 0.2, 0.3, 0.4, or even 0.5; and not more than 2, 2.5, 3, 3.5, 4, 4.5, or even 5% by weight used based on the total weight of monomers fed to the polymerization.

The fluorine-containing polymers can be obtained with any of the known polymerization techniques including solution polymerization, suspension polymerization and polymerization in super critical CO₂. The polymers are preferably made through an aqueous emulsion polymerization process, which can be conducted in a known manner including batch, semi-batch, or continuous polymerization techniques. The reactor vessel for use in the aqueous emulsion polymerization process is typically a pressurizable vessel capable of withstanding the internal pressures during the polymerization reaction. Typically, the reaction vessel will include a mechanical agitator, which will produce thorough mixing of the reactor contents and heat exchange system.

Any quantity of the monomer(s) and the sulfonate-containing monomers may be charged to the reactor vessel. The monomers and/or the sulfonate-containing monomers may be charged batchwise or in a continuous or semicontinuous manner. By semi-continuous is meant that a plurality of batches of the monomer and/or and the sulfonate-containing monomers are charged to the vessel during the course of the polymerization. The independent rate at which the monomers and/or the sulfonate-containing monomers are added to the kettle, will depend on the consumption rate with time of the particular monomer and/or the sulfonate-containing monomer. Preferably, the rate of addition of monomer and/or the sulfonate-containing monomers will equal the rate of consumption of monomer, i.e., conversion of monomer into polymer, and/or the sulfonate-containing monomers.

In one embodiment, the sulfonate-containing monomer may be neutralized, for example with ammonia, to aid in its incorporation into the fluoropolymer.

In the case of aqueous emulsion polymerization, the reaction kettle is charged with water. To the aqueous phase there is generally also added a fluorinated surfactant, typically a non-telogenic fluorinated surfactant although aqueous emulsion polymerization without the addition of fluorinated surfactant may also be practiced. When used, the fluorinated surfactant is typically used in amounts of 0.01% by weight to 1% by weight. Suitable fluorinated surfactants include any fluorinated surfactant commonly employed in aqueous emulsion polymerization. Particularly preferred fluorinated surfactants are those that correspond to the general formula:

Y—R_{f}—Z—X

wherein Y represents hydrogen, Cl or F; R_{f} represents a linear or branched perfluorinated alkylene having 4 to 10 carbon atoms; Z represents COO⁻ or SO₃⁻ and X represents an alkali metal ion or an ammonium ion. Exemplary emulsifiers include: ammonium salts of perfluorinated alkanoic acids, such as perfluorooctanoic acid and perfluorooctane sulphonic acid.

Also contemplated for use in the preparation of the polymers described herein are emulsifiers of the general formula:

[R_{f}—O—L—COO⁻]ᵢX₁⁻ (VI)

wherein L represents a linear partially or fully fluorinated alkylene group or an aliphatic hydrocarbon group, R_{f} represents a linear partially or fully fluorinated aliphatic group or a linear partially or fully fluorinated group interrupted with one or more oxygen atoms, Xᵢ⁺ represents a cation having the valence i and i is 1, 2 and 3. Specific examples are described in, for example, US Pat. Publ. 2007/0015937 (Hintzer et al.). Exemplary emulsifiers include: CF₃CF₂OCF₂CF₂OCF₂COOH, CHF₂(CF₂)₅COOH, CF₃(CF₂)₆COOH, CF₃O(CF₂)₃OCF(CF₃)COOH, CF₃CF₂CH₂OCF₂CH₂OCF₂COOH, CF₃O(CF₂)₃OCHFCF₂COOH, CF₃O(CF₂)₃OCF₂COOH, CF₃(CF₂)₃(CH₂CF₂)₂CF₂CF₂CF₂COOH, CF₃(CF₂)₂CH₂(CF₂)₂COOH, CF₃(CF₂)₂COOH, CF₃(CF₂)₂(OCF(CF₃)CF₂)OCF(CF₃)COOH, CF₃(CF₂)₂(OCF₂CF₂)₄OCF(CF₃)COOH, CF₃CF₂O(CF₂CF₂O)₃CF₂COOH, and their salts. In one embodiment, the molecular weight of the emulsifier is less than 1500, 1000, or even 500 grams/mole.

These emulsifiers may be used alone or in combination as a mixture of two or more of them. The amount of the emulsifier is well below the critical micelle concentration, generally within a range of from 250 to 5,000 ppm (parts per million), preferably 250 to 2000 ppm, more preferably 300 to 1000 ppm, based on the mass of water to be used.

A chain transfer agent may be used to control the molecular weight of the polymer so as to obtain the desired zero shear rate viscosity. Useful chain transfer agents include C₂-C₆ hydrocarbons such as ethane, alcohols, ethers, esters including aliphatic carboxylic acid esters and malonic esters, ketones and halocarbons. Particularly useful chain transfer agents are dialkylethers such as dimethyl ether and methyl tertiary butyl ether.

In one embodiment, the polymerization is initiated after an initial charge of the monomer and/or the sulfonate-containing monomer by adding an initiator or initiator system to the aqueous phase. For example, peroxides can be used as free radical initiators. Specific examples of peroxide initiators include, hydrogen peroxide, diacylperoxides such as diacetylperoxide, dipropionylperoxide, dibutyrylperoxide, dibenzoylperoxide, benzoylacetylperoxide, diglutaric acid peroxide and dilaurylperoxide, and further water soluble per-acids and water soluble salts thereof such as e.g. ammonium, sodium or potassium salts. Examples of per-acids include peracetic acid. Esters of the peracid can be used as well and examples thereof include tert-butylperoxyacetate and tert-butylperoxypivalate. A further class of initiators that can be used are water soluble azo-compounds. Suitable redox systems for use as initiators include for example a combination of peroxodisulphate and hydrogen sulphite or disulphite, a combination of thiosulphate and peroxodisulphate or a combination of peroxodisulphate and hydrazine. Exemplary persulphates include: sodium peroxodisulphates, potassium peroxodisulphates, ammonium peroxodisulphates.

Exemplary initiators that can be used are ammonium-alkali- or earth alkali salts of persulfates, permanganic or manganic acid or manganic acids. The amount of initiator employed is typically between 0.03 and 2% by weight, preferably between 0.05 and 1% by weight based on the total weight of the polymerization mixture. The full amount of initiator may be added at the start of the polymerization or the initiator can be added to the polymerization in a continuous way during the polymerization until a conversion of 70 to 80%. One can also add part of the initiator at the start and the remainder in one or separate additional portions during the polymerization. Accelerators such as for example water-soluble salts of iron, copper and silver may also be added.

During the initiation of the polymerization reaction, the sealed reactor kettle and its contents are conveniently pre-heated to the reaction temperature. Polymerization temperatures are from 20° C. to 150° C., preferred from 30° C. to 110° C. and most preferred from 40° C. to 100° C. The polymerization pressure is typically between 4 and 30 bar, in particular 8 to 20 bar. The aqueous emulsion polymerization system may further comprise auxiliaries, such as buffers and complex-formers.

The amount of polymer solids that can be obtained at the end of the polymerization is typically between 10% and 45% by weight, preferably between 20% and 40% by weight and the average particle size of the resulting fluoropolymer is typically between 50 nm and 500 nm. During work-up these particles sizes may be further increased to the final particle sizes by standard techniques (such as, e.g., agglomeration or melt-pelletizing).

In one embodiment, the polymer may further comprise interpolymerized units of a monomer such as: halogenated alkenes, a fluoroalkyl substituted ethylene, allyl iodide, fluorinated alkyl vinyl ethers, fluorinated alkoxy vinyl ethers, olefins, acrylates, styrene, vinyl ethers, and combinations thereof.

Exemplary monomers include: tetrafluoroethylene, hexafluoropropylene, trifluoroethylene, vinylidene fluoride, vinyl fluoride, bromotrifluoroethylene, chlorotrifluoroethylene, CF₃CH═CF₂, C₄F₉CH═CH₂, CF₂═CHBr, CH₂═CHCH₂Br, CF₂═CFCF₂Br, CH₂═CHCF₂CF₂Br, CH₂═CHI, CF₂═CHI, CF₂═CFI, CH₂═CHCH₂I, CF₂═CFCF₂I, CH₂═CHCF₂CF₂I , CF₂═CFCH₂CH₂I, CF₂═CFCF₂CF₂I, CH₂═CH(CF₂)₆CH₂CH₂I, CF₂═CFOCF₂CF₂I, CF₂═CFOCF₂CF₂CF₂I, CF₂═CFOCF₂CF₂CH₂I, CF₂═CFCF₂OCH₂CH₂I, CF₂═CFO(CF₂)₃—OCF₂CF₂I, CH₂═CHBr, (CF₂═CFOC₄F₈SO₂)⁻ᵢM⁺ⁱ, wherein M is a cation with a valence i, and others as is known in the art.

After polymerization, the resulting emulsion or dispersion may be coagulated using techniques known in the art to harvest the fluoropolymer. The traditional methods of coagulating fluoropolymer dispersions include: physical and chemical methods. In physical methods the dispersion may be subject to strong (high) shearing using a stirring device thereby coagulating the particles, (typically by rotor stator having shear rates in excess of 1000 (1/s)). Another method of physical coagulation is the freeze-thaw method. The dispersion is cooled sufficiently to freeze it, which destabilizes the dispersion so that on thawing, the coagulate separates from the liquid. In chemical coagulation, an electrolyte (i.e., a conducting media) or inorganic salt is added to the dispersion so that the stability of the dispersion is decreased thereby causing coagulation. Examples of electrolytes used to chemically coagulate fluoropolymer primary particles include HCl, H₂SO₄, HNO₃, H₃PO₄, Na₂SO₄, MgCl₂, Al₂(SO₄)₃, and ammonium carbonate. Examples of inorganic salts used to chemically coagulate fluoropolymer primary particles include alkali metal salts, alkaline earth metal salts, and ammonium salts of nitric acid, hydrohalic acid (such as hydrochloric acid), phosphoric acid, sulfuric acid, molybdate, monobasic or dibasic sodium phosphate, ammonium bromide, potassium chloride, calcium chloride, copper chloride and calcium nitrate. These electrolytes and inorganic salts may be used independently or in combinations of two or more.

In one embodiment, the coagulation or work up of the fluoropolymer dispersion can impact the performance of the fluorine-containing polymer as a polymer processing additive.

In one embodiment, the resulting fluorine-containing polymer comprises a polymer that is partially fluorinated (i.e., the polymer backbone, excluding the terminal groups, comprises at least one C—F bond and at least one C—H bond). In one embodiment, the polymer backbone is highly fluorinated, meaning that 80%, 90%, 95%, or even 100% of the C—H bonds along the polymer backbone are replaced by C—F bonds, excluding the terminal ends, i.e., where the polymerization initiates and terminates.

The resulting fluorine-containing polymers of the present disclosure may be unimodial, having one molecular weight size distribution, or multimodial, have two or more molecular weight size distributions.

The fluorine-containing polymers of the present disclosure, comprise at least three —(SO₃⁻) ᵢM⁺ⁱ groups per polymer chain. These sulfonate groups provide ionic branch points off the polymer backbone. Theses ionic groups can then cluster, “ionically crosslinking” the polymer together.

In one embodiment, the fluorine-containing polymer comprising sulfonate groups is a pseudo-branched polymer. Although not wanting to be limited by theory, it is believed that the sulfonate-containing groups impart apparent branching of the polymer through association of the ionic groups.

Branching can be described as providing short chain branching, wherein the branching is only a few carbon atoms (e.g., less than 10) long, or long chain branching, wherein the branching is multiple carbon atoms (e.g., 100 to 1000) long.

The level of branching or non-linearity for long chain branching can be characterized through the long chain branching index (LCBI). The LCBI can be determined as described in R. N. Shroff, H. Mavridis; Macromol., 32, 8464-8464 (1999) & 34, 7362-7367 (2001) according to the equation:

$$LCBI = \frac{{η}_{0 , br .}^{1 \text{/} a}}{{[ η ]}_{br .}} \cdot \frac{1}{{k}^{1 \text{/} a}} - 1 \qquad eq . 1$$

In the above equation, η_{0,br} is the zero shear viscosity (units Pa·s) of the branched polymer measured at a temperature T and [η]_{br} is the intrinsic viscosity (units ml/g) of the branched polymer at a temperature T′ in a solvent in which the branched polymer can be dissolved and α and k are constants. These constants are determined from the following equation:

η_{0,lin}=k·[η]ₗᵢₙ^{α} eq. 2

wherein η_{0,lin} and [η]ₗᵢₙ represent respectively the zero shear viscosity and intrinsic viscosity of the corresponding linear polymer measured at the respective same temperatures T and T′ and in the same solvent. Thus, the LCBI is independent of the selection of the measurement temperatures and solvent chosen provided of course that the same solvent and temperatures are used in equations 1 and 2.

Generally, the effectiveness of the fluorine-containing polymer to decrease melt defects will increase with an increasing value of the LCBI for polymers having similar zero shear rate viscosities (η₀). However, when the level of branching becomes too large, the polymer may have a gel fraction that cannot be dissolved in an organic solvent and the LCBI value cannot be measured accurately since the measurement is based on a soluble solution. At such high levels of branching, the advantageous effects of the fluorine-containing polymer on the processing of the melt-processible polymer composition are reduced as the melt viscosity of the fluoropolymer is too high. One skilled in the art through routine experimentation may readily determine the appropriate value of LCBI. Generally, the LCBI will be between 0.2 and 5, preferably between 0.5 and 1.5. In one embodiment, the LCBI is greater than 0.2, 0.5, 1, 1.5, 2, 2.5, 4, or even 6.

In one embodiment of the present disclosure, the fluorine-containing polymer of the present disclosure comprise a higher LCBI value, than the same polymer prepared with an alternate branching agent, such as a halogenated olefin.

The fluorine-containing polymer comprising sulfonate groups may be amorphous, i.e., they have no melting point or hardly show a melting point; or semicrystalline, i.e., polymers that have a clearly detectable melting point.

The fluorine-containing polymers comprising sulfonate groups are melt-processible. This means the fluorine-containing polymers have an appropriate melt-viscosity that they can be melt-extruded at the temperatures applied for melt-processing the non-fluorinated polymers. Melt processing typically is performed at a temperature from 180° C. to 280° C., although optimum operating temperatures are selected depending upon the melting point, melt viscosity, and thermal stability of the polymer and also the type of extruder used.

Even though the fluorine-containing polymer comprises acidic end-groups, in one embodiment of the present disclosure, the selection of the cation can impact the melt-processability of the composition. In one embodiment, the melt-processible polymer composition comprises a plurality of trivalent or tetravalent cations. Exemplary cations include: Al⁺³, Fe⁻³, Ce⁺³, Ce⁺⁴, and combinations thereof. In one embodiment, the melt-processible polymer composition comprises a sufficient amount of the plurality of trivalent and/or tetravalent cations to partially neutralize (at least 25, 50, 75, or even 90% neutralize) the acidic end-groups of the fluorine-containing polymer. In one embodiment, the melt-processible polymer composition comprises a sufficient amount of the plurality of trivalent and/or tetravalent cations to completely neutralize (e.g., 100% or present even in excess) the acidic end-groups of the fluorine-containing polymer.

Fluorine-Containing Polymer Compositions

The fluorine-containing polymers provided herein may be used as processing aids for facilitating or improving the quality of the extrusion of non-fluorinated polymers. They can be mixed with non-fluorinated polymers during extrusion into polymer articles. They can also be provided as polymer compositions, so-called masterbatches, which may contain further components and/or one or more host polymers. Typically master batches contain the fluorine-containing polymer dispersed in or blended with a host polymer, which typically is a non-fluorinated polymer. Masterbatches may also contain further ingredients, such as synergists, lubricants, etc. The masterbatch may be a composition ready to be added to a non-fluorinated polymer for being extruded into a polymer article. The materbatch may also be a composition that is ready for being directly processed into a polymer articles without any further addition of non-fluorinated polymer.

The fluorine-containing polymer can be melt-processed (e.g., melt extruded) at the temperatures applied. Melt-processing typically is performed at temperatures from 180° C. to 280° C., although optimum operating temperatures are selected depending upon the melting point, melt viscosity, and thermal stability of the composition and also the type of melt-processing equipment used. Generally, the composition may have a melt-flow index (measured according to ASTM D1238 at 190° C., using 2160 g weight) of 5.0 g/10 minutes or less, preferably 2.0 g/10 minutes or less. Generally the melt flow indexes are greater than 0.1 or greater than 0.2 g/10 min.

Such composition may be mixed with further non-fluorinated polymer and/or further components to obtain a composition ready for processing into a polymer article. The composition may also contain all required ingredients and are ready for being extruded into a polymer article. The amount of the fluorine-containing polymer in these compositions is typically relatively low. The exact amount used may be varied depending upon whether the extrudable composition is to be extruded into its final form (e.g. a film) or whether it is to be used as a master batch or processing additive which is to be (further) diluted with additional host polymer before being extruded into its final form.

Generally, the fluorine-containing polymer composition comprises from about 0.002 to 50 weight % of the fluorine-containing polymer. If the fluorine-containing polymer composition is a master batch or processing additive, the amount of fluoropolymer may vary between about 1 to 50 weight % of the composition. If the fluorine-containing polymer composition is to be extruded into final form and is not further diluted by the addition of host polymer, it typically contains a lower concentration of the fluorine-containing polymer, e.g., about 0.002 to 2 wt %, and preferably about 0.005 to 0.2 wt % of the fluorine-containing polymer composition. In any event, the upper concentration of the fluorine-containing polymer used is generally determined by economic limitations rather than by adverse physical effects of the concentration of the fluorine-containing polymer composition.

In one embodiment, the composition may comprise blends of fluorine-containing polymers which comprise different MFIs, Mooney viscosity, and/or LCBIs. See for example, U.S. Pat. No. 6,277,919 (Dillon et al.).

In another embodiment, the composition may comprise a second polymer processing additive as is known in the art, such as a fluoropolymer obtained from a bisolefin, a fluoropolymer obtained from a halogenated olefin, siloxanes, etc.

The fluorine-containing polymer composition may be used in the form of a powder, pellet, granule of a desired particulate size or size distribution, or any other extrudable form.

The fluorine-containing polymer compositions may comprise fluorine-containing polymers having average particle sizes (weight average) of greater than about 50 nm, or greater than about 500 nm or greater than about 2 μm or even greater than about 10 μm. In a typical embodiment, the fluorine-containing polymer may have an average particle size (weight average) of from about 1 to about 30 μm.

Non-Fluorinated Polymers (Host Polymers)

A wide variety of non-fluorinated polymers are useful as host polymers. The non-fluorinated melt processible polymers may be selected from a variety of polymer types. Host polymers include, but are not limited to, hydrocarbon resins, polyamides (including but not limited to nylon 6, nylon 6/6, nylon 6/10, nylon 11, nylon 12, poly(iminoadipolyliminohexamethylene), poly(iminoadipolyliminodecamethylene), and polycaprolactam), polyester (including but not limited to poly (ethylene terephthalate) and poly (butylene terephthalate)), chlorinated polyethylene, polyvinyl resins such as polyvinylchoride, polyacrylates and polymethylacrylates, polycarbonates, polyketones, polyureas, polyimides, polyurethanes, polyolefins and polystyrenes.

The non-fluorinated polymers host polymers are melt-processible. Typically, the polymers, including hydrocarbon polymers, have melt flow indexes (measured according to ASTM D1238 at 190° C., using a 2160 g weight) of 5.0 g/10 minutes or less, preferably 2.0 g/10 minutes. Generally the melt flow indexes are greater than 0.1 or 0.2 g/10 min.

A particularly useful class of host polymers are hydrocarbon polymers, in particular, polyolefins. Representative examples of useful polyolefins are polyethylene, polypropylene, poly (1-butene), poly (3-methylbutene), poly (4-methylpentene) and copolymers of ethylene with propylene, 1-butene, 1-hexene, 1-octene, 1-decene, 4-methyl-1-pentene, and 1-octadecene.

Representative blends of useful polyolefins include blends of polyethylene and polypropylene, linear or branched low-density polyethylenes (e.g. those having a density of from 0.89 to 0.94 g/cm³), high-density polyethylenes (metallocene-catalyzed or not metallocene-catalyzed), including those having a density of e.g. from 0.94 to about 0.98 g/cm³, and polyethylene and olefin copolymers containing said copolymerizable monomers, some of which are described below, e.g., ethylene and acrylic acid copolymers; ethylene and methyl acrylate copolymers; ethylene and ethyl acrylate copolymers; ethylene and vinyl acetate copolymers; ethylene, acrylic acid, and ethyl acrylate copolymers; and ethylene, acrylic acid, and vinyl acetate copolymers.

The polyolefins may be obtained by the homopolymerization or copolymerization of olefins, as well as copolymers of one or more olefins and up to about 30 weight percent or more, but preferably 20 weight percent or less, of one or more monomers that are copolymerizable with such olefins, e.g. vinyl ester compounds such as vinyl acetate. The olefins may be characterized by the general structure CH₂═CHR, wherein R is a hydrogen or an alkyl radical, and generally, the alkyl radical contains not more than 10 carbon atoms, preferably from one to six carbon atoms. Representative olefins are ethylene, propylene, 1-butene, 1-hexene, 4-methyl-1-pentene, and 1-octene. Representative monomers that are copolymerizable with the olefins include: vinyl ester monomers such as vinyl acetate, vinyl propionate, vinyl butyrate, vinyl chloroacetate, and vinyl chloropropionate; acrylic and alpha-alkyl acrylic acid monomers and their alkyl esters, amides, and nitriles such as acrylic acid, methacrylic acid, ethacrylic acid, methyl acrylate, ethyl acrylate, N,N-dimethyl acrylamide, methacrylamide, and acrylonitrile; vinyl aryl monomers such as styrene, o-methoxystyrene, p-methoxystyrene, and vinyl naphthalene; vinyl and vinylidene halide monomers such as vinyl chloride, vinylidene chloride, and vinylidene bromide; alkyl ester monomers of maleic and fumaric acid and anhydrides thereof such as dimethyl maleate, diethyl maleate, and maleic anhydride; vinyl alkyl ether monomers such as vinyl methyl ether, vinyl ethyl ether, vinyl isobutyl ether, and 2-chloroethyl vinyl ether; vinyl pyridine monomers; N-vinyl carbazole monomers; and N-vinyl pyrolidine monomers.

Useful host polymers also include the metallic salts of the olefin copolymers, or blends thereof, which contain free carboxylic acid groups. Illustrative of the metals that can be used to provide the salts of said carboxylic acids polymers are the one, two, and three valence metals such as sodium, lithium, potassium, calcium, magnesium, aluminum, barium, zinc, zirconium, beryllium, iron, nickel, and cobalt.

In one embodiment, useful host polymers also include blends of various thermoplastic polymers and blends thereof containing conventional adjuvants such as antioxidants, light stabilizers, fillers, antiblocking agents, and pigments.

The host polymers may be used in the form of powders, pellets, granules, or in any other extrudable form.

The most preferred olefin polymers useful in the invention are hydrocarbon polymers such as homopolymers of ethylene and propylene or copolymers of ethylene and 1-butene, 1-hexene, 1-octene, 4-methyl-1-pentene, propylene, vinyl acetate and methyl acrylate.

The melt processible composition of the present disclosure can be prepared by any of a variety of ways. For example, the host polymer and the fluorine-containing polymer can be combined together by any of the blending means usually employed in the plastics industry, such as with a compounding mill, a Banbury mixer, or a mixing extruder in which the fluoropolymer is uniformly distributed throughout the host polymer. The fluorine-containing polymer and the host polymer may be used in the form, for example, of a powder, a pellet, or a granular product. The mixing operation is most conveniently carried out at a temperature above the melting point or softening point of the fluoropolymer, though it is also feasible to dry-blend the components in the solid state as particulates and then cause uniform distribution of the components by feeding the dry blend to a twin-screw melt extruder.

The resulting melt-blended mixture can be pelletized or otherwise comminuted into a desired particulate size or size distribution and fed to an extruder, which typically will be a single-screw extruder, that melt-processes the blended mixture. Melt-processing typically is performed at a temperature from 180° C. to 280° C., although optimum operating temperatures are selected depending upon the melting point, melt viscosity, and thermal stability of the blend. Different types of extruders that may be used to extrude the compositions of this invention are described, for example, by Rauwendaal, C., “Polymer Extrusion”, Hansen Publishers, p. 23-48, 1986. The die design of an extruder can vary, depending on the desired extrudate to be fabricated. For example, an annular die can be used to extrude tubing, useful in making fuel line hose, such as that described in U. S. Pat. No. 5,284, 184 (Noone et al.), which description is incorporated herein by reference.

The blended composition can contain conventional adjuvants such as antioxidants, antiblocks, pigments, and fillers, e.g. titanium dioxide, carbon black, and silica.

Antiblocks, such as talc, silica (e.g., diatomaceous earth), and nepheline syenite, when used, may be coated or uncoated materials. In one embodiment, a synergist is added to the melt-processible composition. By ‘synergist’ is meant a compound, generally non-fluorinated organic compound, that allows the use of a lower amount of the fluorine-containing polymer while achieving essentially the same improvement in extrusion and processing properties of the non-fluorinated polymer as if a higher amount of the fluorine-containing polymer was used.

Exemplary synergists include: polyethylene glycol, polycaprolactone, silicone-polyethers, aliphatic polyesters, aromatic polyesters, amine oxides, carboxylic acids, fatty acid esters, and combinations thereof.

The fluorine-containing polymer may also be combined with a poly (oxyalkylene) polymer component as a so-called synergist. The poly (oxyalkylene) polymer component may comprise one or more poly (oxyalkylene) polymers. A useful processing additive composition comprises between about 5 and 95 weight percent of the poly (oxyalkylene) polymer component and 95 and 5 weight percent of the fluorine-containing polymer. Typically, the ratio of the fluorine-containing polymer to the poly (oxyalkylene) polymer component in the processing aid will be from 1/2 to 2/1.

The poly (oxyalkylene) polymer component generally may comprise between about 0.002 and 20 weight percent of the overall melt processible composition, more preferably between about 0.005 and 5 weight percent, and most preferably between about 0.01 and 1 weight percent. Generally, poly (oxyalkylene) polymers useful in this invention include poly (oxyalkylene) polyols and their derivatives. A class of such poly (oxyalkylene) polymers may be represented by the general formula:

A[(OR³)ₓOR²]_{y}

wherein: A is an active hydrogen-free residue of a low molecular weight, initiator organic compound having a plurality of active hydrogen atoms (e.g., 2 or 3), such as a polyhydroxyalkane or a polyether polyol, e.g., ethylene glycol, glycerol, 1,1,1-trimethylol propane, and poly (oxypropylene) glycol; y is 2 or 3; (OR³)ₓ is a poly (oxyalkylene) chain having a plurality of oxyalkylene groups, OR³ wherein the R³ moieties can be the same or different and are selected from the group consisting of C₁ to C₅ alkylene radicals and, preferably, C₂ or C₃ alkylene radicals, and x is the number of oxyalkylene units in said chain. Said poly (oxyalkylene) chain can be a homopolymer chain, e.g., poly (oxyethylene) or poly (oxypropylene), or can be a chain of randomly distributed (i.e., a heteric mixture) oxyalkylene groups, e.g., a copolymer —OC₂H₄— and —OC₃H₆— units, or can be a chain having alternating blocks or backbone segments of repeating oxyalkylene groups, e.g., a polymer comprising (—OC₂H₄—)ₐ and (—OC₃H₆—)_{b} blocks, wherein a+b=5 to 5000 or higher, and preferably 10 to 500.

R² is H or an organic radical, such as alkyl, aryl, or a combination thereof such as aralkyl or alkaryl, and may contain oxygen or nitrogen heteroatoms. For example, R₂ can be methyl, butyl, phenyl, benzyl, and acyl groups such as acetyl, benzoyl and stearyl.

Representative poly (oxyalkylene) polymer derivatives can include poly (oxyalkylene) polyol derivatives wherein the terminal hydroxy groups have been partly or fully converted to ether derivatives, e.g., methoxy groups, or ester derivatives, e.g., stearate groups. Other useful poly (oxyalkylene) derivatives are polyesters, e.g., prepared from dicarboxylic acids and poly (oxyalkylene) glycols. Preferably, the major proportion of the poly (oxyalkylene) polymer derivative by weight will be the repeating oxyalkylene groups, (OR³).

The poly (oxyalkylene) polyols and their derivatives can be those which are solid at room temperature and have a molecular weight of at least about 200 and preferably a molecular weight of about 400 to 20,000 or higher. Poly (oxyalkylene) polyols useful in this invention include polyethylene glycols which can be represented by the formula H(OC₂H₄)ₙOH, where n is about 15 to 3000, such as those sold by Dow Chemical Co., Midland, Mich., under the trade designation “CARBOWAX”, such as “CARBOWAX PEG8000”, where n is about 180, e.g. 181, and those sold under the trade name “POLYOX”, such as “POLYOX WSR N-10” where n is about 2300, e.g. 2272.

As an alternative to or in combination with a poly (alkyleneoxy) polymer, there can also be used any of the following polymers as synergists: i) silicone-polyether copolymers; ii) aliphatic polyesters such as poly (butylene adipate), poly (lactic acid) and polycaprolactone polyesters and iii) aromatic polyesters such as phthalic acid diisobutyl ester.

A preferred aliphatic polyester is a polycaprolactone having a number average molecular weight in the range 1000 to 32000, preferably 2000 to 10000, and most preferably 2000 to 4000.

The melt-processible compositions of the present disclosure may be used in articles. In one embodiment, the fluorine-containing polymer composition is useful in the extrusion of non-fluorinated polymers, which includes for example, extrusion of films, extrusion blow molding, injection molding, pipe, wire and cable extrusion, and fiber production.

Embodiments of the present disclosure include:

Embodiment 1. A melt-processible polymer composition comprising:
a non-fluorinated melt-processible polymer; and
a fluorine-containing polymer comprising at least three —(SO₃⁻)ᵢM⁺¹ groups per polymer chain wherein M is a cation; and i is an integer.

Embodiment 2. The melt-processible polymer composition of embodiment 1, wherein M comprises at least one of: H, Mg, Na, Ca, K, Zn, a quaternary ammonium group, triphenylbenzyl phosphonium, tributyl alkyl phosphonium, tributyl benzyl ammonium, tetrabutyl ammonium, triarylsulfonium, and combinations thereof.

Embodiment 3. The melt-processible polymer composition of any one of the previous embodiments, wherein M comprises a trivalent or tetravalent cation.

Embodiment 4. The melt-processible polymer composition of embodiment 3, wherein M comprises Al, Fe, Ce, and combinations thereof.

Embodiment 5. The melt-processible polymer composition of any one of the previous embodiments, the melt-processible polymer composition comprising 0.001 to 10% by weight of the fluorine-containing polymer versus the non-fluorinated melt-processible polymer.

Embodiment 6. The melt-processible polymer composition of any one of the previous embodiments, wherein the fluorine-containing polymer is derived from the polymerization of a fluorinated monomer and a sulfonate-containing monomer.

Embodiment 7. The melt-processible polymer composition of embodiment 6, wherein the sulfonate-containing monomer comprises at least one of: (CF₂═CF—O(CF₂)ₙ—SO₃⁻)ᵢM⁺ⁱ; (CH₂═CH—(CF₂)ₙ—SO₃⁻)ᵢM⁺ⁱ; (CF₂═CF—O[CF₂CF(CF₃)O]ₙ(CF₂)ₒ—SO₃⁻)ᵢM⁺¹; and combinations thereof, where n is at least 1, o is at least 1, and M is a cation and I is an integer.

Embodiment 8. The melt-processible polymer composition of any one of the previous embodiments, wherein the fluorine-containing polymer is crystalline.

Embodiment 9. The melt-processible polymer composition of any one of embodiments 1-7, wherein the fluorine-containing polymer is semi-crystalline, or amorphous.

Embodiment 10. The melt-processible polymer composition of any one of the previous embodiments, wherein the fluorine-containing polymer is partially fluorinated.

Embodiment 11. The melt-processible polymer composition of any one of embodiments 1-9, wherein the fluorine-containing polymer is perfluorinated.

Embodiment 12. The melt-processible polymer composition of any one of the previous embodiments, wherein the fluorine-containing polymer has an LCBI of greater than 0.2.

Embodiment 13. The melt-processible polymer composition of any one of the previous embodiments, further comprising a synergist.

Embodiment 14. The melt-processible polymer composition of embodiment 13, wherein the synergist is polyethylene glycol or polycaprolactone.

Embodiment 15. The melt-processible polymer composition of any one of the previous embodiments, further comprising an antiblocking agent.

Embodiment 16. The melt-processible polymer composition of any one of the previous embodiments, wherein the fluorine-containing polymer has a bimodal size distribution.

Embodiment 17. The melt-processible polymer composition of any one of the previous embodiments, wherein the fluorine-containing polymer has an acidic end-group concentration of greater than 10 meq/kg of fluorine-containing polymer.

Embodiment 18. The melt-processible polymer composition of any one of the previous embodiments, wherein the non-fluorinated melt-processible polymer comprises at least one of polypropylene, polyethylene, and combinations thereof.

Embodiment 19. An article comprising the melt-processible polymer composition of any one of the previous embodiments.

Embodiment 20. A polymer melt additive composition for use as a processing aid in the extrusion of a non-fluorinated polymer, the polymer melt additive composition comprising a fluorine-containing polymer comprising at least three —(SO₃⁻)ᵢM⁺¹ groups per polymer chain wherein M is a cation, and combinations thereof; and i is an integer.

Embodiment 21. The polymer melt additive composition embodiment 20, further comprising a synergist.

Embodiment 22. A polymer melt additive composition for use as a processing aid in the extrusion of a non-fluorinated polymer, the polymer melt additive composition comprising (a) a fluorine-containing polymer comprising (i) a —(SO₃⁻)ᵢM⁺¹ group wherein M is a cation; and i is an integer and (ii) an acidic end-group concentration of greater than 10 meq/kg and (b) a plurality of trivalent or tetravalent cations.

Embodiment 23. The polymer melt additive composition of embodiment 22, wherein the fluorine-containing polymer is partially neutralized by the plurality of trivalent or tetravalent cations.

Embodiment 24. The polymer melt additive composition of embodiment 22, wherein the fluorine-containing polymer is completely neutralized by the plurality of trivalent or tetravalent cations.

Embodiment 25. The polymer melt additive composition of any one of embodiments 22-24, wherein the plurality of trivalent or tetravalent cations comprise at least one of Al⁺³, Fe⁺³, Ce⁺³, Ce⁺⁴, and combinations thereof.

Embodiment 26. The polymer melt additive composition of any one of embodiments 22-25, wherein the polymer melt additive composition comprises an acidic end-group concentration of greater than 30 meq/kg.

Embodiment 27. The polymer melt additive composition of any one of embodiments 22-26, wherein the a fluorine-containing polymer comprises at least three —(SO₃⁻)ᵢM⁺ⁱ groups per polymer chain.

Embodiment 28. The polymer melt additive composition of any one of embodiments 22-27, further comprising a synergist.

Embodiment 29. The polymer melt additive composition of embodiment 28, wherein the synergist is polyethylene glycol, polycaprolactone, or combinations thereof.

Embodiment 30. A method for making a polymer melt additive composition comprising:

polymerizing a fluorine-containing polymer; and

coagulating the fluorine-containing polymer with (a) acid coagulation or (b) use of a trivalent or tetravalent salt.

wherein the fluorine-containing polymer comprises (i) a —(SO₃⁻)ᵢM⁺ⁱ group wherein M is a cation; and i is an integer and (ii) an acidic end-group concentration of greater than 10 meq/kg of fluorine-containing polymer.

Embodiment 31. The method of embodiment 30, wherein the trivalent or tetravalent cation comprises at least one of Al⁺³, Fe⁺³, Ce⁺³, Ce⁺⁴, and combinations thereof.

Embodiment 32. The method of any one of embodiments 30-31, further comprising a synergist.

Embodiment 33. The method of embodiment 32, wherein the synergist is polyethylene glycol, polycaprolactone, or combinations thereof.

### EXAMPLES

Advantages and embodiments of this disclosure are further illustrated by the following examples, but the particular materials and amounts thereof recited in these examples, as well as other conditions and details, should not be construed to unduly limit this invention. In these examples, all percentages, proportions and ratios are by weight unless otherwise indicated.

All materials are commercially available, for example from Sigma-Aldrich Chemical Company; Milwaukee, Wis., or known to those skilled in the art unless otherwise stated or apparent.

These abbreviations are used in the following examples: g=gram, hr=hour, kg=kilograms, min=minutes, cm=centimeter, mm=millimeter, ml=milliliter, dl=deciliter, l=liter, mol=moles, kPa=kilopascals, MPa=megapascals, FT-IR=Fouier Transform Infrared Spectroscopy, psi=pressure per square inch, [η]=intrinsic viscosity, rad/s=radians/sec SI unit of angular velocity, rpm=revolutions per minute, ppm=parts per million, MV=Mooney Viscosity, MI=melt index in g/10 min @190° C. and 2.6 kg weight, and wt=weight.

### Materials

| Acronym | Description |
|---|---|
| Fluoropolymer | An elastomeric copolymer of VDF and HFP with a |
| C | fluorine content of 65.9 wt % available as “FE-1000A” |
| | from 3M company, Maplewood, MN |
| LLDPE 2.0 | 2.0 MI Ziegler-Natta LLDPE available as |
| | “EXXONMOBIL LLDPE LL 1002.09” from Exxon |
| | Mobil (Irving, TX) as a granular resin |
| LLDPE 0.9 | 0.9 MI Ziegler-Natta LLDPE available as |
| | “MARFLEX 7109” from Chevron Phillips Chemical |
| | Co. LP, The Woodlands, TX |
| Antioxidant | Blend of “IRGAFOS 168” and “IRGANOX 1076” |
| | available from BASF under the trade name |
| | “IRGANOX B 900” |
| Zn Stearate | Commercially available as “Zinc Stearate 33238” from |
| | Alfa Aesar, Ward Hill, MA |
| Al₂(SO₄)₃ | Commercially available from Sigma-Aldrich, Inc, |
| | St. Louis, MO |
| Sodium | Commercially available from Cargill Inc, |
| Chloride | Minneapolis MN |
| Magnesium | Commercially available from NedMag Industries, |
| Chloride | Veendam, The Netherlands |
| Antiblock | Commercially available under the trade name |
| | “ABT 7500” or MB #101558 from Ampacet, |
| | Tarrytown, NY |
| Slip Agent | 5% erucamide in polyethyelene concentrate, |
| | commercially available as MB #10090 from Ampacet, |
| | Tarrytown, NY |

Synthesis of Monomer 1 (perfluoro-3-oxa-7-sulfonic acid-1-heptene)

In a 3-neck 1 liter round bottom flask equipped with a mechanical stirrer, condenser and a thermocouple was charged 50 g (0.13 mol) of CF₂═CF—O—C₄F₈—SO₂F (prepared as described in U.S. Pat. No. 6,624,328) and 120 g ethanol. The solution was stirred and heated to 40° C. Addition of 9.9 g, 0.23 mol CaH2 was done in small charges over one hour. The mixture was cooled to 25° C. and 50 g (0.5 mol) concentrated sulfuric acid diluted with 250 g water was added over 30 min. The product was extracted with 150 g methyl t-butyl ether. Solvent was vacuumed stripped to yield 33 g product for a 66% yield. NMR confirmed the desired product, CF₂=CF—O—C₄F₈—SO₃H.

In a 200 ml round bottom flask containing a stir bar 11 g (0.03 mol) CF₂═CF—O—C₄F₈—SO₃H was charged with 50 g water and stirred. Addition of 3.5 g NH₄OH containing 27% NH₃ was added to give a pH of 10. Water was vacuumed stripped for a quantitative yield of CF₂═CF—O—C₄F₈—SO₃NH₄ as a dry white solid confirmed by NMR.

Polymerization Method

The polymerization procedure is given below for Example 1 (EX 1). Other samples used the same procedure, but modified with the amounts shown in the tables.

To an autoclave was added 2.350 liters of water, 5.0 g potassium phosphate as buffer, 20 g of ammonium persulphate (APS), 10.5 g of the sulfonate monomer (30 g of a 35% solution of Monomer 1+8.3 g 28% ammonia) and a further 325 g water as a rinse. The reactor temperature was maintained at 74° C. (165° F.). After a series of three nitrogen purges and evacuations the final vacuum was broken with a small amount of hexafluoropropylene (HFP). Vinylidenefluoride (VDF) and HFP were then added at a ratio of HFP/VDF=0.651 until a reaction pressure of 155 psig was reached. The total amounts of VDF and HFP are reported in Table 1 as a PreCharge. As monomer was converted to polymer, monomer was fed to the reactor at a ratio of HFP/VDF of about 0.651, with the amounts used reported in Table 1 as VDF and HFP Feeds. In this way, a constant pressure was maintained until 750 g of VDF was added to the reactor. At the end of the polymerization, the remaining monomer was vented, the reactor cooled, and the latex recovered. Latex was coagulated with a MgCl₂ solution, rinsed with deionized water, and then dried overnight at 127° C. (260° F.).

Analysis

Mooney Viscosity (MV) of the fluoropolymer was tested according to ASTM D1646-06 Part A by a MV 2000 instrument (available from Alpha Technologies, Ohio, USA) using a large rotor (ML 1+10) at both 100° C. and 121° C. The Mooney viscosities reported are in Mooney units.

Measured Monomeric Composition of Polymer: The monomeric composition of the polymer was assessed using a Nicolet Nexus 470 Spectrometer and 6700 systems with OMNIC software (Thermo Fisher Scientific, Waltham, Mass.). The samples were tested against a calibration curve obtained from fluoropolymer of known composition. For the experimental samples and the calibration samples, a small sample of the polymer was dissolved in acetone at 10% wt., coated on a KBr crystal, and dried. The intensity of the peak at 1397 cm⁻¹ normalized to the 1474-752 cm⁻¹ region was used to measure the relative monomer ratio.

Fluoropolymer 1-4 and A-B

Fluoropolymer 1-4 and A were prepared using the Polymerization Method described above using the amounts of monomer listed in Table 1 below. For Ex 2, 5.25 g of the sulfonate monomer (15 g of a 35% solution of Monomer 1+4.1 g 28% ammonia) was used.

Fluoropolymer B was prepared similarly to the Polymerization Method described above using the amounts of monomer listed in Table 1, except that a 40 L kettle was used instead and the pressure was at 160 psi (not 155 psi) with 46.7 g of APS used (instead of 20 g) and 17 g DEM (diethyl malonate) added. A constant pressure was maintained until about 6732 g of VDF was added to the reactor.

TABLE 1

| | VDF | HFP | VDF | HFP | |
|---|---|---|---|---|---|
| Fluoro- | PreCharge | PreCharge | Feeds | Feeds | Monomer 1 |
| polymer | (g) | (g) | (g) | (g) | (g) |
| A | 157.9 | 111.2 | 750.2 | 480.8 | 0 |
| B | 487.9 | 697 | 6732 | 4385 | 0 |
| 1 | 177.1 | 137.0 | 750.4 | 485.6 | 10.5 (0.85 wt. %) |
| 2 | 241.3 | 177.3 | 751.5 | 491.5 | 5.25 (0.42 wt. %) |
| 3 | 155.2 | 122.1 | 750.6 | 485.8 | 10.5 (0.85 wt. %) |
| 4 | 148.9 | 119.8 | 750.6 | 485.7 | 10.5 (0.85 wt. %) |

Fluoropolymers A-B and 1-2 were analyzed for Mooney Viscosity and the Measured Monomeric Composition of the polymer. The results are shown in Table 2 below.

TABLE 2

| | | Monomeric | | | | | Total |
|---|---|---|---|---|---|---|---|
| | | Composition | | | | | Rxn |
| | | VDF | HFP | F | Solids | | Time |
| Fluoropolymer | MV | (wt. %) | (wt. %) | wt. % | wt. % | pH | (min) |
| A | 45.6 | 61.8 | 38.2 | 65.7 | 32.67 | 2.85 | 136 |
| B | 63.1 | 62.6 | 37.4 | 65.6 | 31.95 | 3.94 | 218 |
| 1 | 51.5 | 60.2 | 39.8 | 66.0 | 24.84 | 2.82 | 129 |
| 2 | 71.8 | 69.0 | 31.0 | 64.5 | 28.29 | 3.36 | 104 |

Melt Processible Polymer Composition Preparation 1

A master batch (MB) was prepared using 43.65 g of LLDPE 0.9 and 1.35 g of the specified fluoropolymer. The master batch was prepared in a Haake mixer equipped with a Rheomix 600 mixing bowl (capacity of 60 ml (45 g)) at 190° C. using a 2 minute loading period (15 rpm) and a one minute rpm ramp to 50 rpm, followed with mixing at 50 rpm for 5 minutes. The material was cooled and cut into half inch cubes with a guillotine.

The master batch was diluted at 1000 ppm fluoropolymer into LLDPE 0.9. For this purpose, a Polylab mixing bowl was used (253 ml, 190 g capacity). The mixing sequence was identical to the MB conditions. In this case, 6.33 g of the master batch was mixed with 183.7 g LLDPE 0.9. The samples were then cooled, cubed and granulated using a Thomas Wiley mill.

Capillary Rheometry Test

Extrusion performance of the fluoropolymer processing aid was tested using a Rosand capillary rheometer (Malvern Instruments Ltd., United Kingdom) at 190° C. with a 16×1 mm 180° entry die. For each formulation, the barrel was filled with the Melt Processible Polymer Composition and the formulation was pushed through the die at a shear rate of 250/s. After the barrel was emptied under those conditions, the barrel and die face were cleaned (but the capillary was not emptied). The barrel was re-filled with the same formulation, which was extruded at 250/s until the pressure was stable (1/4 barrel). The remainder of the barrel was extruded using a sequence of shear rates (25, 40, 60, 100, 150, 250, and 400/s), until equilibrium pressure was reached in each case. The pressure of the Melt Processible Polymer Composition was compared to a reference of neat LLDPE 0.9. The difference, expressed as a % of the neat resin, was recorded.

### Examples 1 and 2 (Ex 1-Ex 2) and Comparative Examples A and B (CE A-CE B)

Examples 1 and 2 and Comparative Examples A and B were prepared following the Melt Processible Polymer Composition Preparation 1 described above using the specified fluoropolymers. The Melt Processible Polymer Compositions were tested following the Capillary Rheometry Test and the % pressure reduction are reported in Table 3.

TABLE 3

| | CE B | CE A | EX 2 | EX 1 |
|---|---|---|---|---|
| | Fluoropolymer Used | | | |
| | B | A | 2 | 1 |
| Shear Rate (1/s) | Pressure Reduction (%) | | | |
| 25 | 49% | 44% | 42% | 56% |
| 40 | 57% | 53% | 45% | 57% |
| 60 | 57% | 54% | 46% | 56% |
| 100 | 50% | 50% | 44% | 52% |
| 150 | 44% | 45% | 41% | 47% |
| 250 | 34% | 35% | 35% | 38% |
| 400 | 25% | 25% | 27% | 28% |

Performance at low shear rates in capillary rheometry testing are believed to be indicative of the performance of processing additives. As shown in Table 3 above, Ex 1 had 56% pressure reduction, which is 7 percentage points higher than CE B.

Melt Processible Polymer Composition Preparation 2

The fluoropolymers were compounded into master batches at a level of 3%. A master batch was prepared in a 2 kg batch by shaking vigorously in a bag, 1940 g LLDPE 2.0, 2.0 g of Antioxidant, 1.4 g of Zn stearate, and 60 g of the fluoropolymer.

The power mixture was fed to a laboratory scale, intermeshing, counter rotating, unvented, air cooled, conical twin screw (Haake Buchler Rheomix TW-100, Thermo Fisher Scientific) with a front inside diameter of 20 mm. The mixture was gravity fed to the throat of the extruder, exposed to air at a rate of 50 g/min. The extruder specific temperature profile of the 3 barrel zones (feed, metering, mixing), and die zone was 170/190/200/200° C. respectively. The extruder was run at 150 rpm for the first “compounding” pass. The 2nd pass was run with the same temperature profile but at 90 rpm while flood feeding the material. A 4 minute “purge” of material was discarded at the beginning each pass.

Film Line Testing

The Melt Processible Polymer Composition Preparation 2 was diluted with LLDPE 0.9 to a target level of 350 ppm fluoropolymer in the LLDPE resin at 210° C. (410F), 0.9 mm (36 mil) gap, 14 L/D, 10.5 kg/h (23 lb./h), and 220/s, in combination with 6000 ppm of Antiblock and 1000 ppm of Slip Agent.

The melt fracture performance of the melt-processible composition was conducted using a Kiefel blown film line with a 40 mm, 24/1, grooved feed extruder. The die was of spiral design with a 40-mm diameter and 0.9-mm die gap (36 mil). The pressure was recorded every 10 min and a sample of film was collected. The film was examined for the presence of melt fracture, and the time corresponding to the disappearance of the last band of melt fracture or time to clear melt fracture (TTC) was recorded.

### Examples 3-7 (Ex 3-Ex 7) and Comparative Examples C and D (CE C-CE D)

Comparative Example C uses Fluoropolymer C, which was coagulated with MgCl₂. Comparative Example D was coagulated with MgCl₂. Examples 3 and 4 used the Fluoropolymer 3 as described in Table 1 except that fluoropolymer dispersion was split into two and Example 3 was coagulated with HCl while Example 4 was coagulated with MgCl₂. Examples 5-7 used the Fluoropolymer 4 as described in Table 1 except that fluoropolymer dispersion was split into three and Example 5 was coagulated using a freeze-thaw method, Example 6 was coagulated with NaCl, and Example 7 was coagulated with Al₂(SO₄)₃. Shown in Table 4 is the Mooney Viscosity for the fluoropolymer. The various fluoropolymers were then used in the preparation of Melt Processible Polymer Composition Preparation 2 and tested via Film Line Testing and the results for TTC and T½ are shown in Table 4.

TABLE 4

| | Fluoro- | Coagulation | | TTC | T½ |
|---|---|---|---|---|---|
| Example | polymer | Method | MV | min | min |
| CE C | C | MgCl₂ | 72 | 70 | 31 |
| CE D | B | MgCl₂ | 63 | 100 | 42 |
| 3 | 3 | HCl | 61 | 45 | 17 |
| 4 | 3 | MgCl₂ | 61 | 50 | 20 |
| 5 | 4 | Freeze | 54 | 100 | 27 |
| 6 | 4 | NaCl | 59 | 80 | 32 |
| 7 | 4 | Al₂(SO₄)₃ | 65 | 45 | 13 |

As shown in Table 4, the polymers of the present disclosure have shorter TTC than the comparative examples of higher viscosity. Also shown in Table 4 is that there is an effect of the coagulation method of the fluoropolymer on the TTC.

The metal content in select fluoropolymer samples was measured by ICP (Inductively Couple Plasma) and the results are reported in Table 5 as the milliequivalents (meq) of the metal per kg of the fluorine-containing polymer. A “-” in the table means that the particular metal was not observed above detection limits.

TABLE 5

| | Coagulation | Metal meq/kg | | | | | | | |
|---|---|---|---|---|---|---|---|---|---|
| Fluoropolymer | Method | Al | Ca | Fe | K | Li | Mg | Na | Zn |
| 3 | HCl | — | 0.6 | 1.5 | 3.4 | — | — | 1.7 | — |
| 3 | MgCl₂ | — | 1.3 | — | 6.2 | 0.5 | 51.9 | 2.9 | — |
| 4 | Freeze | 0.7 | 0.4 | — | 12.3 | — | 0.3 | 1.5 | — |
| 4 | NaCl | — | 1.2 | — | 0.8 | — | 0.4 | 15.7 | — |
| 4 | Al₂(SO₄)₃ | 20.4 | 2.1 | — | 2.2 | 3.6 | 0.6 | 2.1 | 1.0 |

Amount of Acid Group

The amount of acid groups present in selected fluorine-containing polymers were tested by titrating the dissolved polymer using a Metrohm 808 automatic titrator and organic solvent tolerant pH electrode (available under the trade designation “Solvotrode” from Metrohm Inc., Riverview, Fla. The fluorine-containing polymers were stirred in a covered container for about 4 hours in methanol (AR grade) and unstabilized tetrahydrofuran. A solvent blank was subtracted from all samples. Tetrabutylammonium hydroxide in methanol was used to titrate the samples and was standardized against potassium hydrogen phthalate. Replicates and relatively large size samples were titrated to ensure and verify homogeneity of the sample. The results were determined in milliequivalent of acidic groups per kilogram fluorine-containing polymer. Results reported are for at least two aliquots. The results are shown in Table 6.

TABLE 6

| | | meq per kg |
|---|---|---|
| | | of fluorine- |
| Fluoro- | Coagulation | containing |
| polymer | Method | polymer |
| 4 | Freeze | 54 ± 1 |
| 4 | Al₂(SO₄)₃ | 40 ± 1 |
| B | Freeze | 25 ± 2 |
| B | Al₂(SO₄)₃ | 20 ± 0 |

Foreseeable modifications and alterations of this invention will be apparent to those skilled in the art without departing from the scope and spirit of this invention. This invention should not be restricted to the embodiments that are set forth in this application for illustrative purposes. To the extent that there is a conflict or discrepancy between this specification and the disclosure in any document incorporated by reference herein, this specification will control.

1. A melt-processible polymer composition comprising:
a non-fluorinated melt-processible polymer; and
a fluorine-containing polymer comprising at least three —(SO₃⁻)ᵢM⁻ⁱ groups per polymer chain wherein M is a cation; and i is an integer, wherein M comprises a trivalent or tetravalent cation.

2. (canceled)

3. (canceled)

4. The melt-processible polymer composition of claim 1, wherein M comprises Al, Fe, Ce, and combinations thereof.

5. The melt-processible polymer composition of claim 1, the melt-processible polymer composition comprising 0.001 to 10% by weight of the fluorine-containing polymer versus the non-fluorinated melt-processible polymer.

6. The melt-processible polymer composition of claim 1, wherein the fluorine-containing polymer is derived from the polymerization of a fluorinated monomer and a sulfonate-containing monomer.

7. The melt-processible polymer composition of claim 6, wherein the sulfonate-containing monomer comprises at least one of: (CF₂═CF—O(CF₂)ₙ—SO₃⁻)ᵢM⁺ⁱ; (CH₂═CH—(CF₂)ₙ—S₃⁻)ᵢM⁺ⁱ; (CF₂═CF—O [CF₂CF(CF₃)O]ₙ(CF₂)ₒ—SO₃⁻)ᵢM⁺ⁱ; and combinations thereof, where n is at least 1, o is at least 1, and M is a cation and I is an integer.

8. The melt-processible polymer composition of claim 1, wherein the fluorine-containing polymer is crystalline.

9. An article comprising the melt-processible polymer composition of claim 1.

10. A polymer melt additive composition for use as a processing aid in the extrusion of a non-fluorinated polymer, the polymer melt additive composition comprising a fluorine-containing polymer comprising at least three —(SO₃⁻)ᵢM⁺ⁱ groups per polymer chain wherein M is a cation, and combinations thereof; and i is an integer.

11. A polymer melt additive composition for use as a processing aid in the extrusion of a non-fluorinated polymer, the polymer melt additive composition comprising (a) a fluorine-containing polymer comprising (i) a —(SO₃⁻)ᵢM⁺ⁱ group wherein M is a cation; and i is an integer and (ii) an acidic end-group concentration of greater than 10 meq/kg and (b) a plurality of trivalent or tetravalent cations.

12. The polymer melt additive composition of claim 11, wherein the fluorine-containing polymer is partially neutralized by the plurality of trivalent or tetravalent cations.

13. The polymer melt additive composition of claim 11, wherein the polymer melt additive composition comprises an acidic end-group concentration of greater than 30 meq/kg.

14. A method for making a polymer melt additive composition comprising:
polymerizing a fluorine-containing polymer; and
coagulating the fluorine-containing polymer with (a) acid coagulation or (b) use of a trivalent or tetravalent salt.
wherein the fluorine-containing polymer comprises (i) a —(SO₃⁻)ᵢM⁺ⁱ group wherein M is a cation; and i is an integer and (ii) an acidic end-group concentration of greater than 10 meq/kg of fluorine-containing polymer.

15. The method of claim 14, wherein the trivalent or tetravalent cation comprises at least one of Al⁺³, Fe⁻³, Ce⁺³, Ce⁺⁴, and combinations thereof.

16. The melt-processible polymer composition of claim 1, wherein the fluorine-containing polymer is semi-crystalline or amorphous.

17. The melt-processible polymer composition of claim 1, wherein the fluorine-containing polymer is partially fluorinated.

18. The melt-processible polymer composition of claim 1, wherein the fluorine-containing polymer has a bimodal size distribution. wherein the fluorine-containing polymer has an acidic end-group concentration of greater than 10 meq/kg of the fluorine-containing polymer.

19. The melt-processible polymer composition of claim 1, further comprising a synergist

20. The melt-processible polymer composition of claim 19, wherein the synergist is polyethylene glycol or polycaprolactone.

21. The melt-processible polymer composition of claim 1, further comprising an antiblocking agent.

22. The melt-processible polymer composition of claim 1, wherein the fluorine-containing polymer has an acidic end-group concentration of greater than 10 meq/kg of fluorine-containing polymer.
